(19) United States
(12) Patent Application Publication
(10) Pub. No.: US 2017/0188565 A1
(43) Pub. Date: Jul. 6, 2017

(54) PEST CONTROL SYSTEM WITH IMPROVED USABILITY

(71) Applicant: Creative Pest Design Inc., Burlington (CA)

(72) Inventors: Kirk Ots, Ajax (CA); Dean Stanbridge, Burlington (CA)

(21) Appl. No.: 14/987,830

(22) Filed: Jan. 5, 2016

(51) Int. Cl. A01M 25/00; A01M 1/20

(52) U.S. Cl. CPC A01M 25/004; A01M 1/2011

(57) ABSTRACT

In an aspect, a pest control system is provided, and includes a housing and a tray. The housing includes a housing body defining a housing compartment, and a housing cover that is removably connectable to the housing body. The housing has at least one aperture to permit access by a target pest to the housing compartment from outside the housing. The tray has a tray body and a tray cover. The tray body contains a pesticide for the target pest and has an opening sized to permit access to the pesticide by the target pest. The tray cover sealingly covers the opening but only covers a portion of an exterior of the tray body. The tray cover is removable from the tray body and is disposable. The tray fits in the housing compartment.

### FIELD OF DISCLOSURE

This disclosure relates generally to pest control systems and more particularly to pest traps that incorporate pesticide.

### BACKGROUND OF DISCLOSURE

It is well-known to provide pest traps both within and outside the home for capturing pests, such as ants and other insects, and also other larger pests such as mice. There are two typical types of traps. A first type is an apparatus that has a chamber with an aperture that permits entry by the pest, and contains a compartment that is filled by the home-owner or by a professional pest control person, with a liquid or granular pesticide. Once the pesticide is consumed, the home-owner then cleans the chamber out by washing the apparatus, thereby washing pesticides down the drain, which is prohibited in at least some jurisdictions. Furthermore, many home-owners do not want to touch the apparatus for fear of coming into contact with the pesticide.

The other typical type of trap is a disposable trap that is self-contained. The home-owner removes the trap from its packaging and places it in a suitable location within the home for catching the target pests. A problem with this type of trap is that as soon as the trap is removed from the packaging, some home-owners believe that they are potentially coming into contact with the pesticide itself, by handling the trap. Furthermore, placing these traps in suitable locations for capturing pests can sometimes mean that they are also accessible by small children and pets who can be harmed by the pesticide.

It would be advantageous to be able to provide a pest control system that at least partially resolves the above noted issues.

### SUMMARY

In an aspect, a pest control system is provided, and includes a housing and a tray. The housing includes a housing body defining a housing compartment, and a housing cover that is removably connectable to the housing body. The housing has at least one aperture to permit access by a target pest to the housing compartment from outside the housing. The tray has a tray body and a tray cover. The tray body contains a pesticide for the target pest and has an opening sized to permit access to the pesticide by the target pest. The tray cover sealingly covers the opening but only covers a portion of an exterior of the tray body. The tray cover is removable from the tray body and is disposable. The tray fits in the housing compartment.

In an aspect, a tray for a pest control system is provided, and includes a tray body and a tray cover. The tray body contains a pesticide for a target pest and has an opening sized to permit access to the pesticide by the target pest. The tray cover sealingly covers the opening but only covers a portion of an exterior of the tray body. The tray cover is removable from the tray body and is disposable.

### BRIEF DESCRIPTION OF DRAWINGS

The foregoing and other aspects of the disclosure will be more readily appreciated by reference to the accompanying drawings, wherein:

FIG. 1 is a perspective view of a pest control system in accordance with an embodiment of the disclosure, in a disassembled state;

FIGS. 2 and 3 show perspective views of a housing cover and a housing body respectively, which are shown in FIG. 1;

FIG. 4 is a perspective view of the housing cover on the housing body to form a housing;

FIG. 5 is a magnified sectional side view of a part of the housing body and the housing cover shown in FIGS. 2 and 3, with an optional breakaway tab;

FIG. 6 is a perspective view of the housing body shown in FIG. 1, with a ground spike mounted thereto;

FIG. 7 is a perspective view of a tray shown in FIG. 1;

FIG. 8 is a perspective view of the tray shown in FIG. 7, with a cover that is partially removed;

FIG. 9 is a perspective view of a tray shown in FIG. 7, with the cover completely removed;

FIG. 10 is a perspective view of the housing body shown in FIG. 3, with a tray containing pesticide in a housing compartment; and

FIG. 11 is a perspective view of the housing body shown in FIG. 10, after the tray has been emptied of its pesticide.

### DETAILED DESCRIPTION

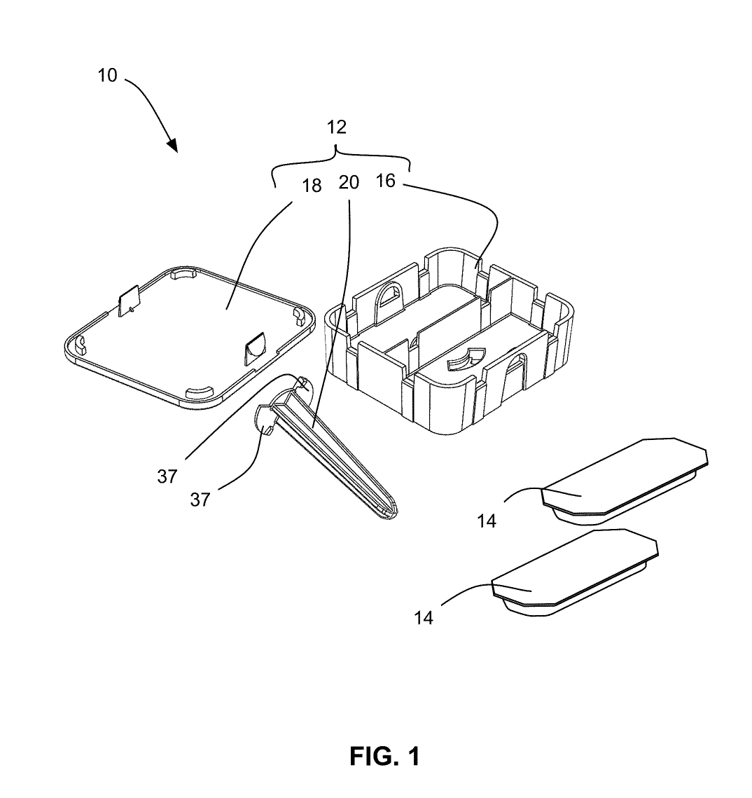

Reference is made to FIG. 1, which shows a pest control system 10 in accordance with an embodiment of the present disclosure. The pest control system 10 includes a housing 12 and at least one tray 14 containing pesticide for insertion into the housing 12.

With reference to FIG. 3, the example housing 12 shown therein includes a housing body 16, a housing cover 18 and a ground spike 20. The housing body 16 defines at least one housing compartment 22 and may include a plurality of housing compartments 22. In the example shown, the housing body 16 defines two housing compartments 22, shown individually at 22a and 22b.

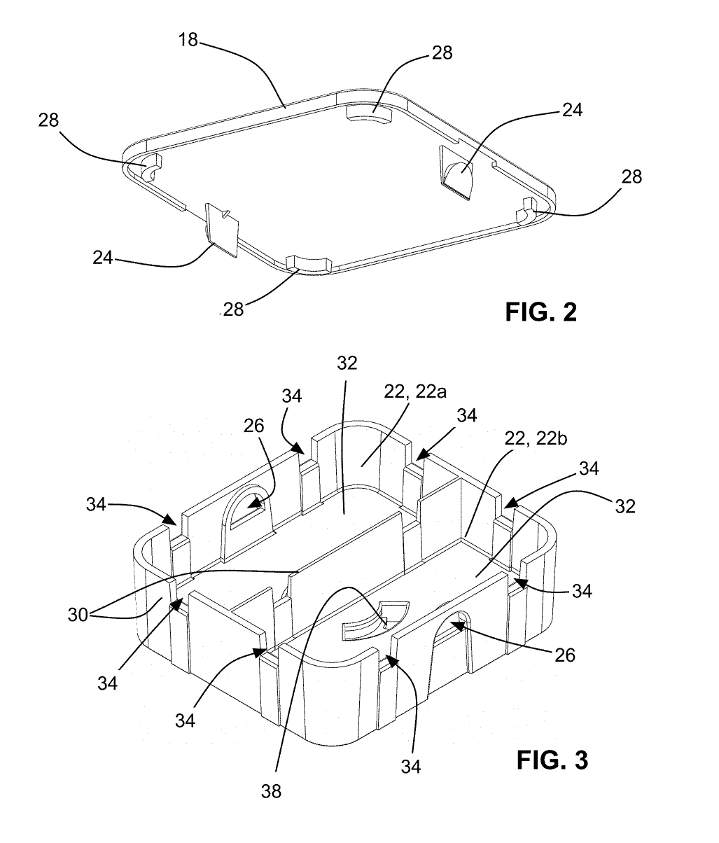

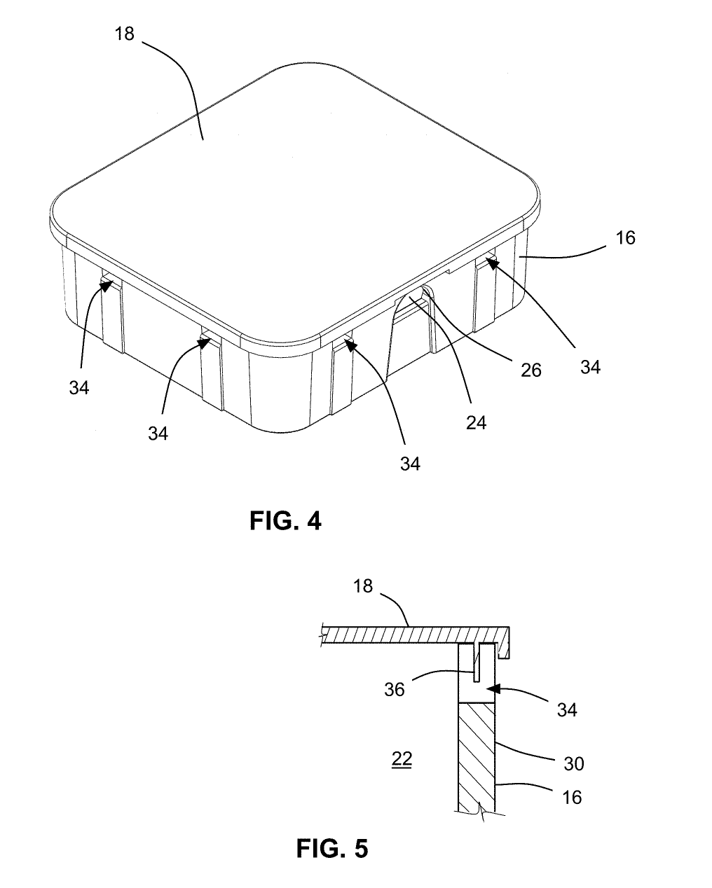

With reference to FIG. 2, the housing cover 18 is removably connectable to the housing body 16 (FIG. 3) so as to cover the housing compartments 22. The housing 12 is shown with the housing cover 18 connected to the housing body 16 in FIG. 4. One or both of the following two functions may be carried out by the housing cover 18 (FIG. 2). The first function may be to substantially prevent viewing of the housing compartments by people and pets in the vicinity of the pest control system 10. In particular, people may not want to be exposed visually to any pests that may be present inside the housing compartments 22 (FIG. 3). Additionally, children (particularly very young children) and pets may be less inclined to manipulate and examine the housing 12 if they cannot easily see what is occurring inside it. For the purpose of carrying out the first function, the cover 18 (and the housing body 16) may be made from an opaque material such as an opaque polymeric material, such as nylon.

The second function that may be carried out by the housing cover 18 may be to substantially prevent easy access by young children and pets to the housing compartments and more particularly to any pesticide and/or pests contained therein. This function may be assisted by providing a plurality of locking tabs 24 (FIG. 2) on the housing cover 18 that releasably engage locking apertures 26 (FIG. 3) on the housing body 16. The locking tabs 24 may be resiliently flexible so as to permit the locking tabs 24 to bend as needed out of the way during placement of the housing cover 18 onto the housing body 16 and then to resiliently extend into the locking apertures 26 to lock the housing cover 18 to the housing body 16. The housing cover 18 may further include alignment projections 28 that engage portions of a wall arrangement shown at 30 of the housing body 16 to help maintain the cover 18 in position on the housing body 16 covering the housing compartments 22. The wall arrangement 30 in part defines the housing compartments 22, along with a floor 32 (FIG. 3) that is present in each compartment 22.

The housing 12 defines at least one pest aperture 34 into each housing compartment 22. In the example shown there are four pest apertures 34 into each housing compartment 22. The pest apertures 34 permit access by a target pest to the housing compartments 22 from outside the housing 12.

With reference to FIG. 5, the pest apertures 34 may be adjustable in size. For example, a breakaway panel 36 may be provided on at least one of the housing body 16 and the cover 18, such that the breakaway panel 36 may be left in place (as shown in FIG. 5) so that only certain pests that are less than a selected first size can get through the pest aperture 34 into the housing 12. Alternatively, the breakaway panel 36 may be broken off so as to permit pests that are less than a selected second (larger) size get through the pest aperture 34 into the housing 12. In some embodiments, each of the pest apertures 34 for one of the housing compartments 22 may be arranged having left the breakaway tabs 36 on, so as to permit entry of a relatively smaller type of pest into that one of the housing compartments 22, while each of the apertures for another one of the housing compartments 22 may be arranged with the breakaway tabs 36 removed so as to permit entry of a second, larger pest into that other one of the housing compartments 22.

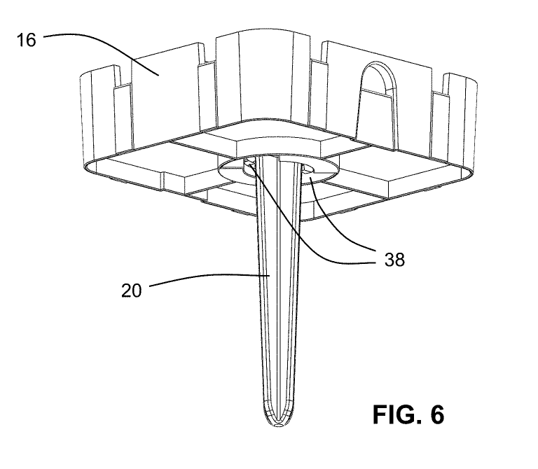

The ground spike 20 may releasably mount to the housing body 16, thereby permitting the pest control system 10 to be fixedly positioned outside in soft ground. The releasable mount may be provided by any suitable structure, such as by means of rotary locking tabs 37 (FIG. 1) that lock into detents in respective J-slots in the housing body 16. A portion of the J-slots can be seen at 38 in FIG. 6.

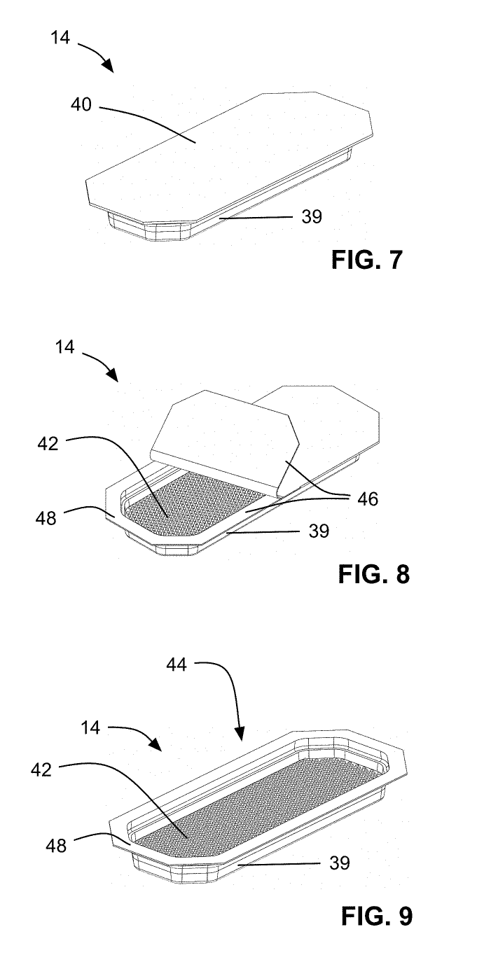

Referring to FIG. 7, each tray 14 may have a tray body 39 and a tray cover 40. The tray body 39 contains a pesticide 42 for the target pest and has an opening 44 (FIG. 9) sized to permit access to the pesticide 42 by the target pest. The tray cover 40 (FIG. 7) sealingly covers the opening 44 but only covers a portion of an exterior of the tray body 39 in the example embodiment shown. The portion of the tray body 39 not covered by the cover 40 has a greater likelihood of being considered by a user to be free of pesticide, and therefore safe to touch after removal of the cover 40. By contrast, if the entirety of the tray body 39 were enveloped in the cover 40, then a user might consider the tray body 39, once unwrapped, potentially coated with pesticide, and therefore unsafe to touch.

The tray cover 40 may sealingly join to the tray body 39 to sealingly cover the opening 44 by any suitable means, such as by an adhesive 46 between the cover 40 and a peripheral flange 48 around the tray body 39.

The tray cover 40 may be peelable from the tray body 39 to expose the opening 44 and the pesticide 42. FIG. 8 shows the cover 40 in a state of partial removal from the tray body 39. Once removed from the tray body 39, the tray cover 40 may be disposable.

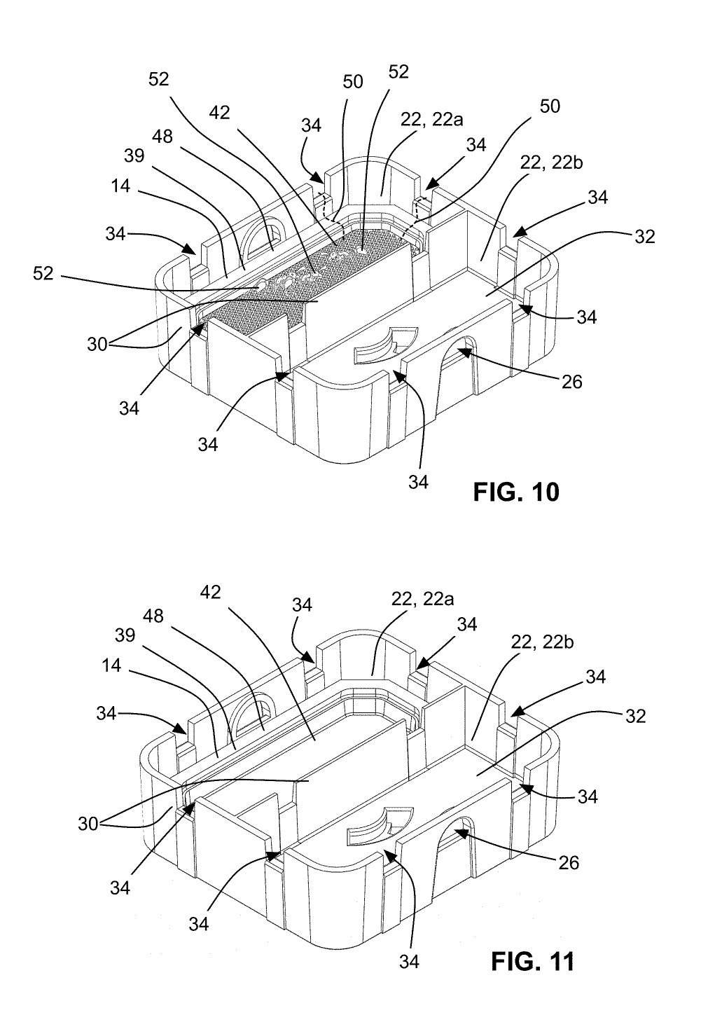

The tray 14 fits in the housing compartment 22 as shown in FIG. 10. Optionally, the peripheral flange 48 on the tray body 39 mating with the walls 30 defining the housing compartment 22 such that few or no pathways exist for the target pest to travel past and beneath the tray body 39. As a result, the tray body 39 substantially blocks off the floor 32 of the housing compartment 22 to access by the target pest. In this way, when the target pest dies in the housing compartment 22, it are more likely to die in the tray 14. As a result, once a tray 14 is used up (i.e. all of its pesticide is gone), as shown in FIG. 11, removal of the tray 14 leaves relatively little cleanup that is required in the housing 12.

In a particular embodiment, whether or not the tray body 39 mates with the walls 30 to permit few or no pathways to the floor 32, the tray body 39 may mate with the walls 30 of the housing compartment to substantially block off the floor 32 of the housing compartment 22 directly below each pest aperture 34, so as to provide a direct path 50 from each aperture 34 to the pesticide 42. By a direct path, it is meant that a path is provided that leads directly from the aperture 34, optionally down some portion of the wall arrangement 30, and directly into the tray 14, without necessitating the pest to crawl along the floor 32 of the housing compartment 22 and climb up the side of the tray 14.

In the embodiment shown, the tray body 39 is made from a transparent material so as to permit easy viewing of the pesticide 42 therein.

Once the pesticide is used up in the tray 14, the tray body 39 may be removed from the housing compartment 22 and may be disposed of.

The target pest itself may be any suitable target pest, such as ants, cockroaches, or any other suitable type of pest. Examples of the target pest are shown at 52 in FIG. 10.

It will further be appreciated that, by providing a plurality of housing compartments 22, a different pesticide tray 14 can be used in each one, thereby permitting a single pest control system 10 to be used to target more than one pest.

The pest control system 10 permits a relatively inexperienced user to complete the task of trapping and disposing of pests that can be present in a home or garden (or business or any other location), without exposing themselves or others in the vicinity to the pesticide used, and with relatively little clean-up. Users may find such a system advantageous over systems where trays are filled by the users themselves from containers of liquid pesticide. Such advantages are present whether the user is a non-professional owner/resident who has a pest control problem, or a professional exterminator wishing to simplify installation of pest control systems.

Those skilled in the art will understand that a variety of other modifications may be effected to the embodiments described herein without departing from the scope of the appended claims.

1. A pest control system, comprising:
a housing, including a housing body defining a housing compartment, and a housing cover that is removably connectable to the housing body, wherein the housing has at least one pest aperture to permit access by a target pest to the housing compartment from outside the housing; and
a tray, having a tray body and a tray cover, wherein the tray body contains a pesticide for the target pest and has an opening sized to permit access to the pesticide by the target pest, wherein the tray cover sealingly covers the opening but only covers a portion of an exterior of the tray body, wherein the tray cover is removable from the tray body and is disposable, wherein the tray fits in the housing compartment.

2. A pest control system as claimed in claim 1, wherein the tray body includes a peripheral flange and substantially blocks off a floor of the housing compartment to access by the target pest.

3. A pest control system as claimed in claim 1, wherein the tray body mates with walls of the housing compartment snuggly so as to substantially block off a floor of the housing compartment directly below the at least one pest aperture, so as to provide a direct path from the at least one aperture to the pesticide that does not include the floor of the housing compartment.

4. A pest control system as claimed in claim 1, wherein the tray body is transparent.

5. A pest control system as claimed in claim 1, wherein the tray body is disposable.

6. A pest control system as claimed in claim 1, wherein the housing body defines a plurality of the housing compartments and wherein the pest control system includes a plurality of the trays, wherein the trays fit in the housing compartments.

7. A pest control system as claimed in claim 1, wherein the housing includes at least one pest aperture that is adjustable in size.

8. A pest control system as claimed in claim 1, wherein the tray cover is sealingly joined to the tray body to sealingly cover the opening, by an adhesive, and is peelable from the tray body to expose the opening.

9. A pest control system as claimed in claim 1, wherein the housing further includes a spike that is removably connectable to the housing body.

10. A tray for a pest control system, comprising a tray body and a tray cover, wherein the tray body contains a pesticide for a target pest and has an opening sized to permit access to the pesticide by the target pest, wherein the tray cover sealingly covers the opening but only covers a portion of an exterior of the tray body, wherein the tray cover is removable from the tray body and is disposable.

11. A tray as claimed in claim 10, wherein the tray body is transparent.

12. A tray as claimed in claim 10, wherein the tray body is disposable.

13. A tray as claimed in claim 10, wherein the tray cover is sealingly joined to the tray body to sealingly cover the opening, by an adhesive, and is peelable from the tray body to expose the opening.
